(19) United States
(12) Patent Application Publication
(10) Pub. No.: US 2023/0163667 A1
(43) Pub. Date: May 25, 2023

(54) STATOR ASSEMBLY APPARATUS AND STATOR ASSEMBLY METHOD

(71) Applicant: HONDA MOTOR CO., LTD., Tokyo (JP)

(72) Inventors: Yasuto OHASHI, Tokyo (JP); Norihiko HIKIMA, Tokyo (JP)

(21) Appl. No.: 18/052,941

(22) Filed: Nov. 7, 2022

(30) Foreign Application Priority Data
Nov. 19, 2021 (JP) 2021-188911

(51) Int. Cl. H02K 15/10; H02K 15/085

(52) U.S. Cl. CPC H02K 15/10; H02K 15/085

(57) ABSTRACT

There are provided leading guide members provided movably along a central axis direction of the stator core, each of the leading guide members being, by moving toward the stator core, inserted into an inside of the respective insulating member before the coil is inserted, and arranged ahead in a movement direction of the coil moving toward the respective slot, in a state of at least a part of the leading guide member being in contact with opening ends of the insulating member. The leading guide member has a quadrilateral shape when viewed in a longitudinal direction. The leading guide member is inclined with one end portion side in a radial direction of the stator core as an apex, and has a shape tapered toward a center line along the radial direction of the stator core; and the apex is arranged on an outer side in the radial direction of the stator core.

This application is based on and claims the benefit of priority from Japanese Patent Application No. 2021-138911, filed on 19 Nov. 2021, the content of which is incorporated herein by reference.

### BACKGROUND OF THE INVENTION

### Field of the Invention

The present invention relates to a stator assembly apparatus and a stator assembly method.

### Related Art

Conventionally, the technology described in Patent Document 1 has been known as a technology for inserting a coil into slots of a stator core in which insulating members are mounted, from inside the stator core while preventing the insulating members from being caught.

In the technology described in Patent Document 1, two guide jigs are inserted into each slot of the stator core in which the insulating members are mounted before insertion of the coil, from outside in the central axis direction of the stator core to open each of the insulating members, and, in that state, the coil is moved in each slot while being applied to one guide jig. After guide members mutually come into contact, the two guide jigs are retreated from inside the slot.

Patent Document 1: Japanese Patent No. 6733823

### SUMMARY OF THE INVENTION

However, in the technology described in Patent Document 1, the shape of the guide jigs on the tip side is such that a pair of side faces with a substantially quadrilateral-shaped section are merely tapered along the radial direction of the stator core. Therefore, if the opening between the opening ends of the insulating member in the slot is almost as narrow as being closed, there is a possibility that it is difficult to insert the guide jigs into the slot.

An object of the present invention is to provide a stator assembly apparatus and a stator assembly method with a good stator assembly workability capable of, even if the opening between opening ends of an insulating member in a slot is almost as narrow as being closed, causing the insulating member to return to an opened state prior to insertion of a coil.

(1) A stator assembly apparatus according to the present invention is a stator assembly apparatus (for example, a stator assembly apparatus 1 described later) for assembling a stator (for example, a stator 200 described later) by inserting a coil (for. example, a belt-shaped coil 100 described later) into each of slots (for example, slots 22 described later) of a stator core (for example, a stator core 2 described later) from inside the stator core, insulating members (for example, pieces of insulating paper 24 described later) being mounted in the slots, the stator assembly apparatus including leading guide members (leading guide members 61 described later) provided movably along a central axis direction of the stator core, each of the leading guide members being, by moving toward the stator core, inserted into an inside of the respective insulating member before the coil is inserted, and arranged ahead in a movement direction of the coil moving toward the respective slot, in a state of at least a part of the leading guide member being in contact with opening ends (for example, opening ends 24a described later) of the insulating member; the leading guide member having a quadrilateral shape when viewed in a longitudinal direction; a tip portion (for example, a tip portion 61a described later) of the leading guide member being inclined along a radial direction of the stator core with one end portion (for example one end portion 61b described later) side in the radial direction of the stator core as an apex (for example, an apex P described later), and having a shape tapered toward a center line (for example, a center line O described later) of the leading guide member along the radial direction of the stator core; and the apex being arranged on an outer side in the radial direction of the stator core.

(2) In the stator assembly apparatus according to (1) above, a lateral width (for example, a lateral width W12 described later) of the leading guide member along a circumferential direction of the stator core is equal to or more than a width (for example, a width W0 described later) of the coil along the circumferential direction of the stator core.

(3) A stator assembly method according to the present invention is a stator assembly method for assembling a stator (for example, the stator 200 described later) by inserting a coil (for example, the belt-shaped coil 100 described later) into each of slots (for example, the slots 22 described later) of a stator core (for example, the stator core 2 described later) from inside the stator core, insulating members (for example, the pieces of insulating paper 24 described later) being mounted in the slots, the stator assembly apparatus including a process of, before inserting the coil into each of the slots, inserting each of leading guide members (for example, leading guide members 61 described later) into an inside of the respective insulating member from an outer side in a central axis direction of the stator core such that the leading guide member is arranged ahead in a movement direction of the coil moving toward the respective slot, in a state of at least a part of the leading guide member being in contact with opening ends (for example, the opening ends 24a described later) of the insulating member; the leading guide member having a quadrilateral shape when viewed in a longitudinal direction; a tip portion (for example, a tip portion 61a described later) of the leading guide member being inclined along a radial direction of the stator core with one end portion (for example one end portion 61b described later) side in the radial direction of the stator core as an apex (for example, an apex P described later), and having a shape tapered toward a center line (for example, a center line O described later) of the leading guide member along the radial direction of the stator core; and the apex being arranged on an outer side in the radial direction of the stator core.

(4) In the stator assembly method according to (3) above, a lateral width (for example, a lateral width W12 described later) of the leading guide member along a circumferential direction of the stator core is equal to or more than a width (for example, a width W0 described later) of the coil along the circumferential direction of the stator core.

According to (1) above, even if the opening between the opening ends of the insulating member is almost as narrow as being closed, it is possible to smoothly insert the leading guide member into the inside of the insulating member. The leading guide member has a quadrilateral shape when viewed in the longitudinal direction, has a shape of being inclined along the radial direction of the stator core with one end portion side in the radial direction of the stator core as the apex and being tapered toward a center line along the radial direction of the stator core, and has a configuration in which the apex is arranged on the outer side in the radial direction of the stator core. The leading guide member is inserted into the slot in the state of at least a part thereof being in contact with the opening ends of the insulating member. Therefore, it is possible to, only by inserting the leading guide member into the inside of the insulating member, cause the opening ends of the insulating member to return to the opened state prior to insertion of the coil. Therefore, it is possible to provide a stator assembly apparatus with a good stator assembly workability.

According to (2) above, since it is possible to cause the opening between the opening ends of the insulating member to open wider than the width of the coil, the insertability of the coil is further improved.

According to (3) above, even if the opening between the opening ends of the insulating member is almost as narrow as being closed, it is possible to smoothly insert the leading guide member into the inside of the insulating member along the central axis direction of the stator core. The leading guide member has a quadrilateral shape when viewed in the longitudinal direction, has a shape of being inclined along the radial direction of the stator core with one end portion side in the radial direction of the stator core as the apex and being tapered toward a center line along the radial direction of the stator core, and has a configuration in which the apex is arranged on the outer side in the radial direction of the stator core. The leading guide member is inserted into the slot in the state of at least a part thereof being in contact with the opening ends of the insulating member. Therefore, it is possible to, only by inserting the leading guide member into the inside of the insulating member, cause the opening ends of the insulating member to return to the opened state prior to insertion of the coil. Therefore, it is possible to provide a stator assembly method with a good stator assembly workability.

According to (4) above, since it is possible to cause the opening between the opening ends of the insulating member to open wider than the width of the coil, the insertability of the coil is further improved.

### BRIEF DESCRIPTION OF THE DRAWINGS

FIG. 1 is a side view showing the appearance of a stator assembly apparatus;

FIG. 2 is a perspective view showing a positioning jig and a coil winding jig in the stator assembly apparatus, the positioning jig and the coil winding jig being disassembled;

FIG. 3 is a perspective view showing insulating members mounted in slots of a stator core;

FIG. 4 is a development view showing an example of a coil;

FIG. 5 is a perspective view showing that a coil expansion device is mounted in the coil winding jig mounted inside the stator core;

FIG. 6 is a diagram of a guide mechanism in the stator assembly apparatus viewed in the central axis direction;

FIG. 7 is a sectional view showing leading guide members in the guide mechanism;

FIG. 8 is a sectional view showing reinforcing guide members in the guide mechanism;

FIG. 9A is a diagram of a tip portion of each leading guide member when viewed along the radial direction of the stator core;

FIG. 9B is a diagram of the tip portion of the leading guide member when viewed along the circumferential direction of the stator core;

FIG. 9C is a diagram of the tip portion of the leading guide member when viewed along the central axis direction of the stator core;

FIG. 10 is a perspective view showing that the guide members are inserted into the slots of the stator core;

FIG. 11A is a diagram showing the shape of the section of each leading guide member in the slot when the leading guide member is inserted into the slot up to a position A in FIGS. 9A and 9B;

FIG. 11B is a diagram showing the shape of the section of the leading guide member in the slot when the leading guide member is inserted into the slot up to a position B in FIGS. 9A and 9B;

FIG. 11C is a diagram showing the shape of the section of the leading guide member In the slot when the leading guide member is inserted into the slot up to a position C in FIGS. 9A and 9B;

FIG. 12A is a diagram illustrating an operation process of inserting the coil into the slots from inside the stator core;

FIG. 12B is a diagram illustrating the operation process of inserting the coil into the slots from inside the stator core;

FIG. 12C is a diagram illustrating the operation process of inserting the coil into the slots from inside the stator core;

FIG. 12D is a diagram illustrating the operation process of inserting the coil into the slots from inside the stator core;

FIG. 12E is a diagram illustrating the operation process of inserting the coil into the slots from inside the stator core;

FIG. 12F is a diagram illustrating the operation process of inserting the coil into the slots from inside the stator core;

FIG. 12G is a diagram illustrating the operation process of inserting the coil into the slots from inside the stator core;

FIG. 12H is a diagram illustrating the operation process of inserting the coil into the slots from inside the stator core;

FIG. 12I is a diagram illustrating the operation process of inserting the coil into the slots from inside the stator core;

FIG. 12J is a diagram illustrating the operation process of inserting the coil into the slots from inside the stator core;

FIG. 13A is a diagram showing that the coil is inserted into each slot;

FIG. 13B is a diagram showing that the coil is inserted into the slot;

FIG. 13C is a diagram showing that the coil is inserted into the slot;

FIG. 13D is a diagram showing that the coil is inserted into the slot;

FIG. 13E is a diagram showing that the coil is inserted into the slot;

FIG. 13F is a diagram showing that the coil is inserted into the slot;

FIG. 13G is a diagram showing that the coil is inserted into the slot;

FIG. 13H is a diagram showing that the coil is inserted into the slot;

FIG. 13I is a diagram showing that the coil is inserted into the slot;

FIG. 13J is a diagram showing that the coil is inserted into the slot; and

FIG. 14 is a perspective view showing the appearance of a stator.

### DETAILED DESCRIPTION OF THE INVENTION

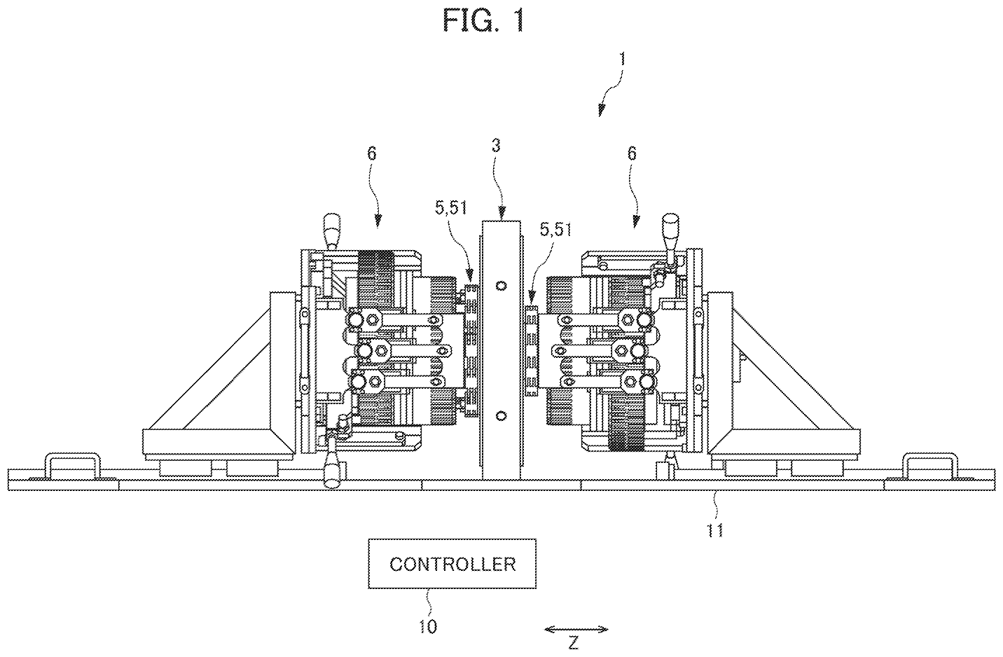

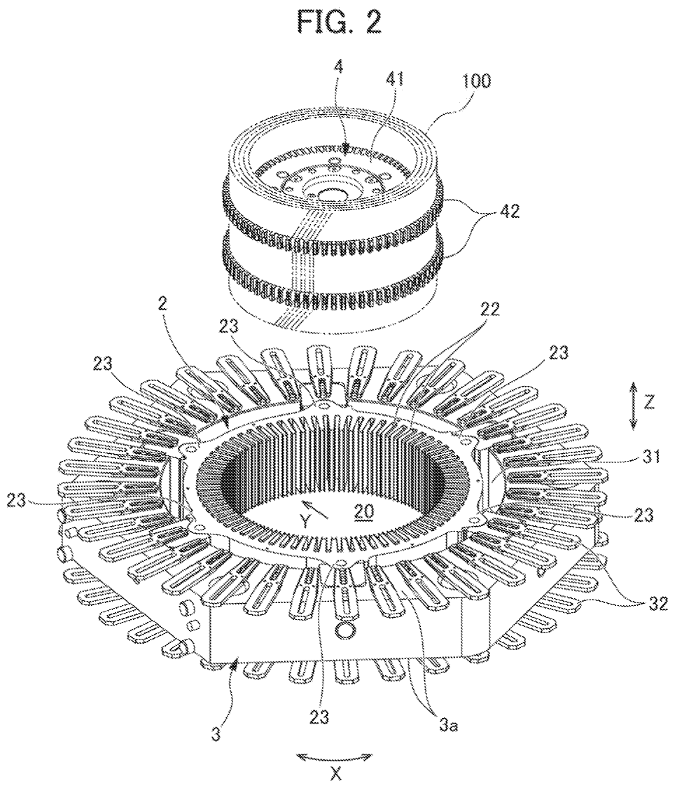

An embodiment of the present invention will be described below in detail with reference to drawings. As shown in FIGS. 1 and 2, a stator assembly apparatus 1 is provided with a stator core 2, a positioning jig 3 that positions and fixes the stator core 2, a coil winding jig 4 around which a belt-shaped coil 100 is annularly wound, coil expansion mechanism units 5 that expand the belt-shaped coil 100 wound around the coil winding jig 4, and guide mechanism units 6 that guide insertion of the belt-shaped coil 100 into slots 22 of the stator core 2.

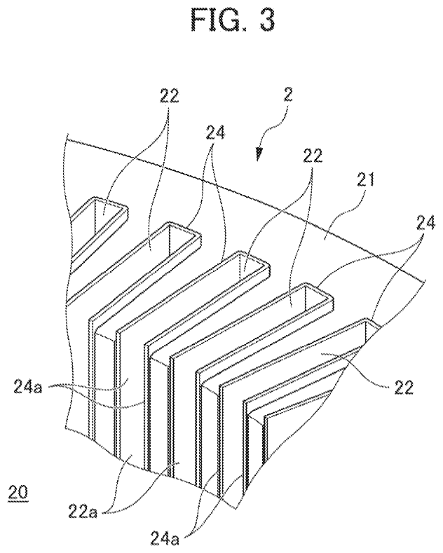

As shown in FIGS. 2 and 3, the stator core 2 has an annular portion 21 configured, for example, with a laminate in which a plurality of thin core plates are laminated. In the center of the annular portion 21, there is a through-hole 20 penetrating the annular portion 21 in the axial direction. The stator core 2 has a plurality of slots 22 penetrating the stator core 2 in the axial direction. The slots 22 are radially arranged at regular intervals along the circumferential direction of the annular portion 21, and have opening portions 22a that are open to the through-hole 20 inside the annular portion 21 in the radial direction. The stator core 2 of the present embodiment has seventy-two slots 22. On the outer periphery of the annular portion 21 of the stator core 2, there are six tab portions 23 protruding at regular intervals.

In the stator core 2 and the positioning jig 3, an X direction in which the slots 22 are arranged is the circumferential direction as shown in FIG. 2. A Y direction along a radial direction from the center of the through-hole 20 is the radial direction. A Z direction orthogonal to the X and Y directions and along the central axis of the through-hole 20 of the stator core 2 is the central axis direction.

As shown in FIGS. 1 and 2, the positioning jig 3 is formed in a hexagonal cylinder shape having a dimension in the central axis direction substantially equal to the dimension of the stator core 2 in the central axis direction, and has, at the center thereof, a stator core insertion hole 31 in which the stator core 2 can be inserted and arranged. The positioning jig 3 fixes the stator core 2 at a predetermined position and in a predetermined posture in the stator core insertion hole 31 by supporting each of the six tab portions 23 of the stator core 2. In the stator assembly apparatus 1 of the present embodiment, the positioning jig 3 is fixed to a center portion of a base 11 of the stator assembly apparatus 1 such that the central axis direction of the stator core 2 fixed in the stator core insertion hole 31 is a horizontal direction.

As shown in FIG. 3, pieces of insulating paper 24, which are insulating members, are mounted in the slots 22 of the stator core 2, respectively, in advance. Each piece of insulating paper 24 is formed by being folded in a substantially U-shape so as to follow the substantially U-shaped inner surface of each slot 22 when the stator core 2 is viewed in the axial direction. The pieces of insulating paper 24 are open to the through-hole 20 inside the stator core 2 in the radial direction. Opening ends 24a of the pieces of insulating paper 24 are arranged at opening portions 22a of the slots 22 and open the insides of the pieces of insulating paper 24 to the through-hole 20.

As shown in FIG. 2, a plurality of cuff guides 32 formed in elongated thin plate shapes are radially arranged on both end faces 3a of the positioning jig 3 in the central axis direction, at regular intervals along the circumferential direction. At the time of inserting the belt-shaped coil 100 described later into the slots 22 of the stator core 2, the cuff guides 32 support the pieces of insulating paper 24 protruding from both end faces of the stator core 2 in the central axis direction and guide movement of the belt-shaped coil 100 into the slots 22. The cuff guides 32 are provided so as to be movable back and forth along the radial direction of the stator core 2 by driving of an actuator such as a cylinder not shown.

The coil winding jig 4 has a jig main body 41 in a substantially cylindrical shape and a plurality of comb tooth portions 42 radially protruding from the outer periphery of the jig main body 41. The comb tooth portions 42 are provided on both end portions of the jig main body 42 in the axial direction. The number of comb tooth portions 42 arranged in the circumferential direction of the jig main body 41 matches the number of slots 22 provided in the stator core 2. In order that the coil winding jig 4 can be inserted in the through-hole 20 of the stator core 2, the coil winding jig 4 is formed such that the outer diameter of the coil winding jig 4 defined by the positions of the tips of the comb tooth portions 42 is equal to or smaller than the hole diameter of the through-hole 20 of the stator core 2.

The belt-shaped coil 100 to be mounted in the stator core 2 is annularly wound over the plurality of comb tooth portions 42. As shown in Fig. 4, the belt-shaped coil 100 is configured with an elongated belt-shaped continuous wave-wound coil formed by flat type conducting wires 101 each of which has a substantially rectangular section. In the case of the continuous wave-wound coil, at the time of setting the coil into the stator core 2, the technology of molding a coil divided in a plurality of segments and welding coil ends after insertion into the slots, which is a technology mainly adopted in the world, is not required. Therefore, it is not necessary to use, for example, high-purity copper material for the coil in order to cope with thermal processing of welding points is eliminated. Therefore, it becomes possible to use recycled copper material that includes impurities, and it is possible to contribute to realization of reuse of resources. Moreover, since the wave-wound coil does not require welding, it is possible to reduce the weight of the coil and reduce the weight of a rotary electric machine using the coil. When the rotary electric machine is mounted on a hybrid car, it is possible to, by the vehicle weight being reduced, reduce carbon dioxide and reduce the harmful effect on the global environment.

The belt-shaped coil 100 has a plurality of straight portions 102 and a plurality of coil end portions 103. The straight portions 102 are parts to be inserted into the slots 22 of the stator core 2, and the straight portions 102 extend substantially linearly and are arranged in parallel at regular intervals. The coil end portions 103 are arranged at positions nearer to the side ends of the belt-shaped coil 100 than the straight portions 102, and alternately connect end portions on one side of adjacent straight portions 102 and end portions on the other side of adjacent straight portions 102 in substantially triangular chevron shapes along the length direction of the belt-shaped coil 100. The coil end portions 103 are parts that protrude from the slots 22 in the axial direction of the stator core 2 when the belt-shaped coil 100 is mounted in the slots 22 of the stator core 2, and are pressed by the coil expansion mechanism units 5 described later when the belt-shaped coil 100 is inserted into the slots 22. The belt-shaped coil 100 of the present embodiment is formed in an elongated belt shape by bundling six flat type conducting wires 101 with the plurality of straight portions 102 and the plurality of coil end portions 103 foldedly formed, such that the straight portions 102 are arranged side by side in parallel at regular intervals.

The coil winding jig 4 winds the belt-shaped coil 100 in many layers by sequentially inserting each of the straight portions 102 of the belt-shaped coil 100 between comb tooth portions 42 from outward before being inserted into the through-hole 20. As a result, as shown in FIG. 2, the coil winding jig 4 around which the belt-shaped coil 100 is wound in an annular shape is configured.

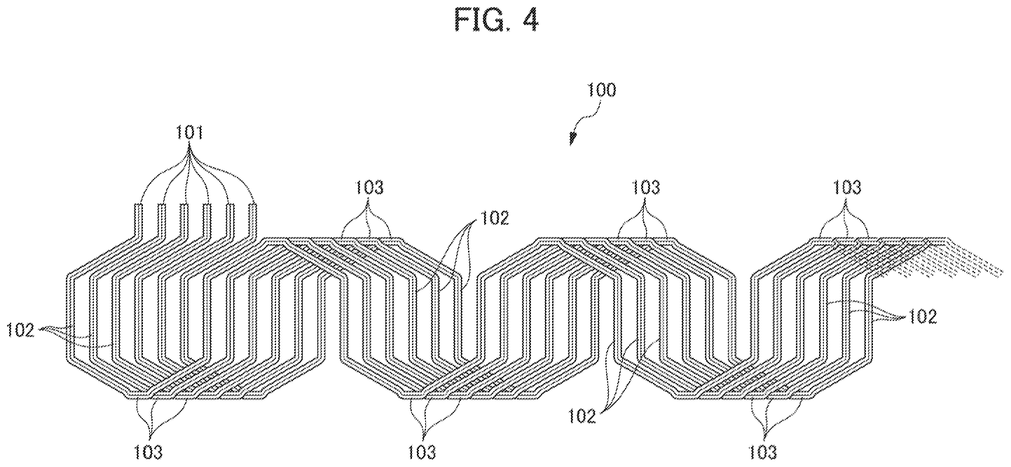

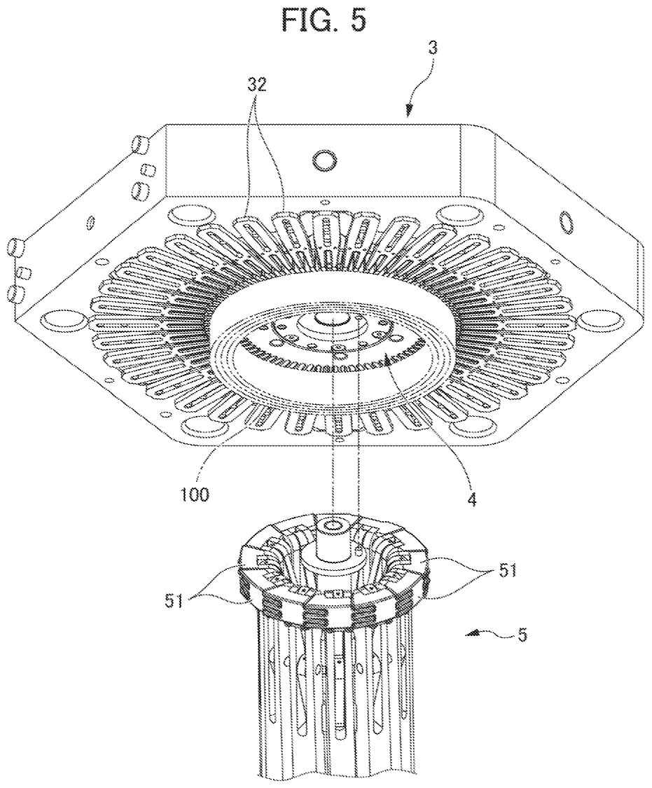

The coil winding jig 4 inserted in the through-hole 20 inside the stator core 2 is held at a predetermined position and in a predetermined posture by being supported by the paired coil expansion mechanism units 5 arranged to face both sides of the stator core 2 in the central axis direction with the positioning jig 3 therebetween. Each of the coil expansion mechanism units 5 of the present embodiment has a substantially cylindrical appearance shape as shown in FIG. 5, and is arranged to face the coil winding jig 4 inserted inside the stator core 2, in the central axis direction of the coil winding jig 4 as shown in FIG. 1. Each of the coil expansion mechanism units 5 is provided so as to be linearly movable on the base 11 and movable in directions of coming into contact with and being separated from the coil winding jig 4 by driving of an actuator not shown.

Each of the coil expansion mechanism units 5 is formed in a substantially cylindrical shape and has a plurality of coil pressers 51 on the outer periphery on the tip side. The plurality of coil pressers 51 are arranged along the outer periphery of the coil expansion mechanism unit 5 on the tip side and provided so as to be expanded and reduced in diameter along the radial direction by driving of an actuator not shown. The outer diameter of the coil pressers 51 in a diameter-reduced state is equal to or smaller than the inner diameter of the annular belt-shaped coil 100 wound around the coil winding jig 4. The outer diameter of the coil pressers 51 in a diameter-expanded state is larger than the outer diameter of the coil winding jig 4. The coil expansion mechanism unit 5 holds the coil winding jig 4 by inserting the coil pressers 51 in the diameter-reduced state inside the annular belt-shaped coil 100 wound around the coil winding jig 4. When the coil pressers 51 inserted in the belt-shaped coil 100 are expanded in diameter, the belt-shaped coil 100 is pressed outward and expanded in diameter. As a result, the straight portions 102 of the belt-shaped coil 100 move toward the insides of the pieces of insulating paper 24 in the slots 22 arranged outside in the radial direction and inserted into the slots 22. The coil pressers 51 of the coil expansion mechanism unit 5 constitute pressers that press the belt-shaped coil 100 outward in the radial direction and cause the straight portions 102 of the belt-shaped coil 100 to move into the insides of the pieces of insulating paper 24 in the slots 22.

As shown in FIG. 1, the paired guide mechanism units 6 are arranged to face both sides of the stator core 2 in the central axis direction with the positioning jig 3 therebetween, similarly to the coil expansion mechanism units 5. The paired guide mechanism units 6 are arranged outside the coil expansion mechanism units 5 in the central axis direction, respectively, the guide mechanism units 6 and the coil expansion mechanism unit 5 being concentric with one another.

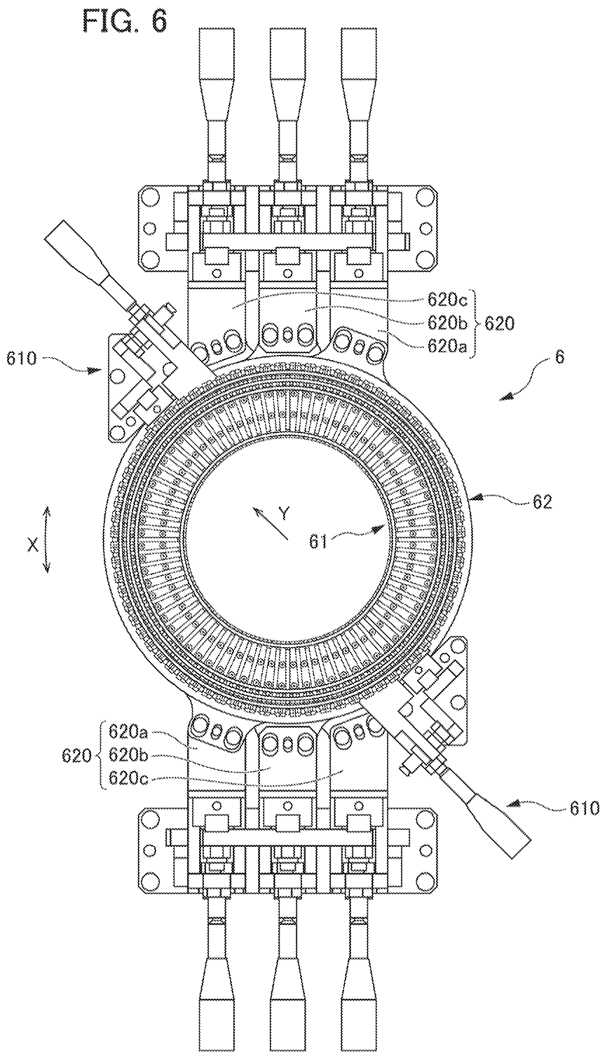

Since the paired guide mechanism units 6 are in the same configuration, the configuration of one guide mechanism unit 6 will be described with reference to FIGS. 6 to 9. FIG. 6 is a diagram of one guide mechanism unit 6 viewed in a direction along the central axis direction of the stator core 2. The guide mechanism unit 6 has a plurality of leading guide members 61 that are annually arranged, and a plurality of reinforcing guide members 62 that are annually arranged on the outer side of the leading guide members 61.

Each of the leading guide members 61 is configured with a rod-shaped body with a length enough for the leading guide member 61 to be inserted inside the piece of insulating paper 24 mounted inside the slot 22. The section orthogonal to the longitudinal direction of the leading guide member 61 is a quadrilateral shape with rounded corners except for a tapered tip portion. Therefore, the leading guide member 61 has a quadrilateral shape when viewed in the longitudinal direction. The longitudinal direction of the leading guide member 61 is arranged along the central axis direction of the stator core 2.

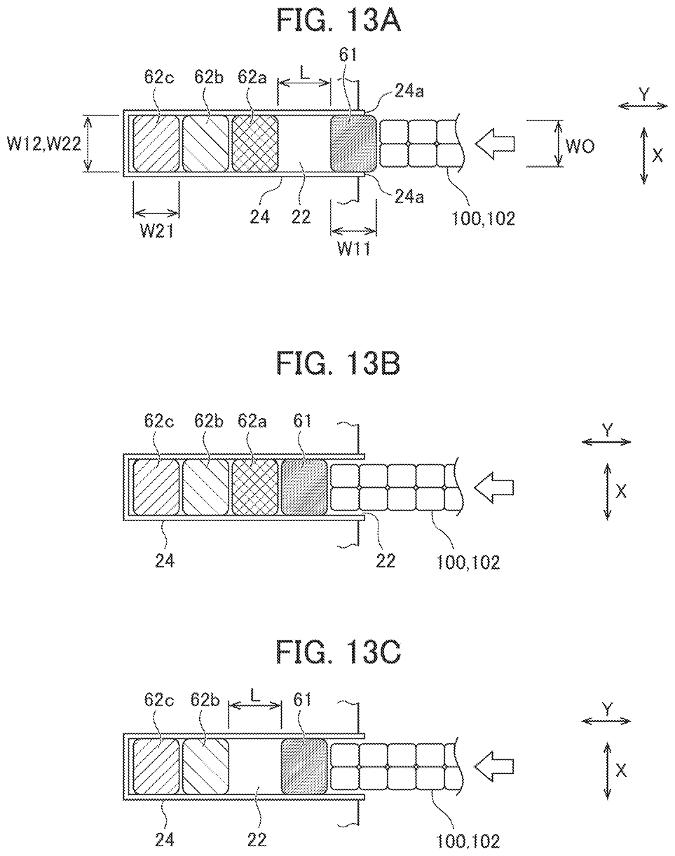

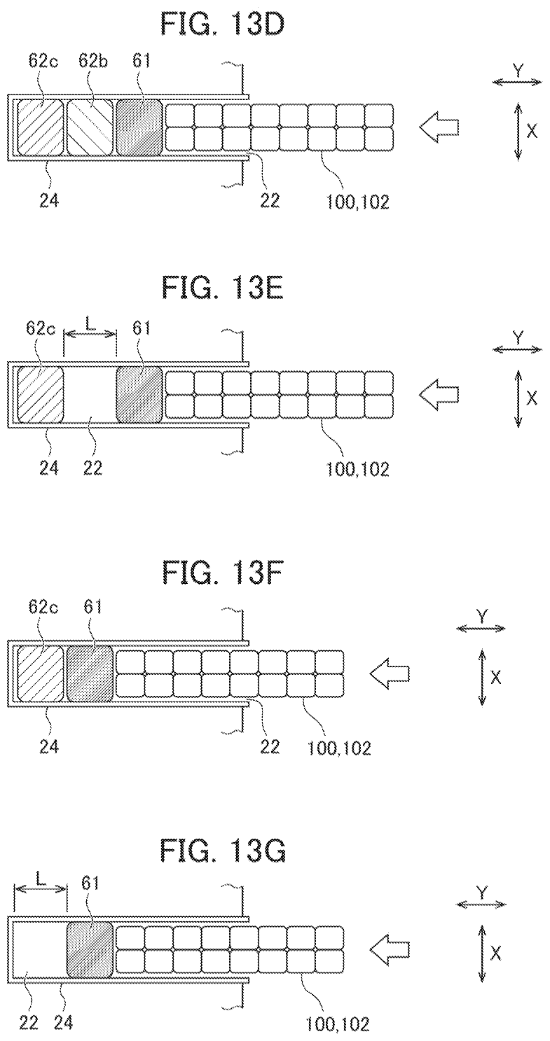

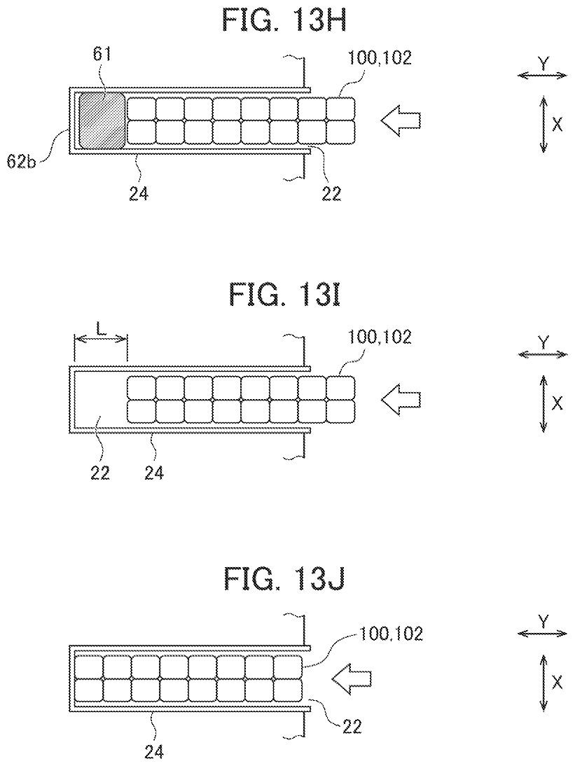

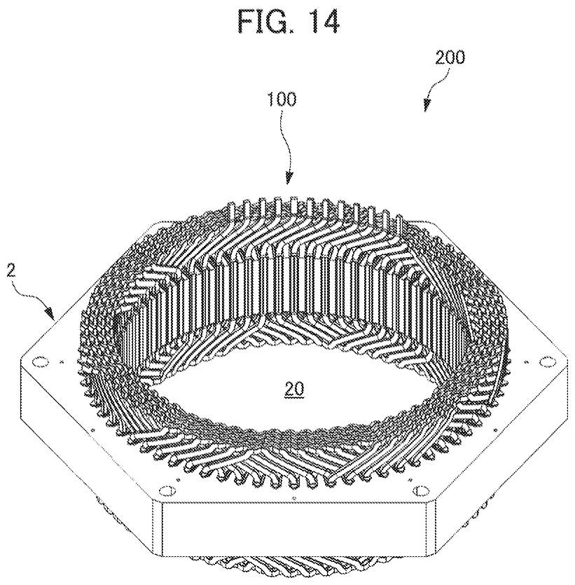

A longitudinal width W11 (see FIG. 13A) of the leading guide member 61 along the radial direction of the stator core 2 is sufficiently smaller than the depth of the slot 22 along the radial direction of the stator core 2. The longitudinal width W11 of the leading guide members 61 of the present embodiment is set to approximately ⅕ of the depth of the slots 22. A lateral width W12 (see FIG. 13A) of each leading guide member 61 along the circumferential direction of the stator core 2 is equal to or smaller than the width inside the piece of insulating paper 24 in the slot 22 along the circumferential direction of the stator core 2. The lateral width W12 of the leading guide members 61 is larger than a width W0 (see FIG. 13A) of the straight portions 102 of the belt-shaped coil 100 inserted into the slots 22 along the circumferential direction of the stator core 2.

At least one leading guide member 61 is provided for one slot 22, and the leading guide members 61 are annularly arranged with the same arrangement pitch as the arrangement pitch of the slots 22. Though one leading guide member 61 is provided for one slot 22 in the present embodiment, a plurality of leading guide members 61 may be provided for one slot 22.

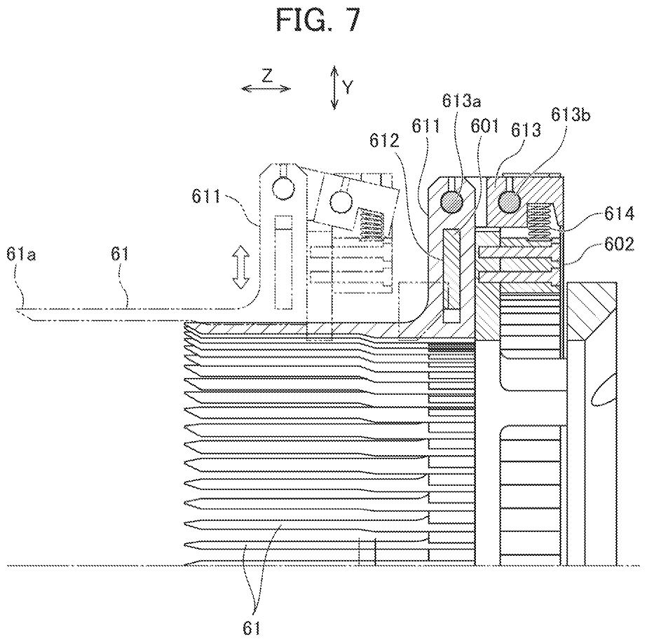

As shown in FIG. 7, the tip of each leading guide member 61 is formed in a tapered shape. The shape of the tip of each leading guide member 6i will be described later. Operation portions 611 are annularly formed on the base end sides of the leading guide members 61, respectively, the operation portions 611 protruding outward in the radial direction. In each of the operation portion 611, a guide hole 612 elongatedly extending outward in the radial direction is provided. In the guide hole 612, a support plate portion 601 provided in the guide mechanism unit 6 is fitted slidably in the radial direction (in the vertical direction in FIG. 7). Each leading guide member 61 is thereby supported by the guide mechanism unit 6 movably in the radial direction.

On the tip end side of the operation portion 611, one end of a connecting plate 613 is rotatably attached by a rotating shaft 613a. The other end of the connecting plate 613 extends in a direction opposite to the direction of extension of the leading guide member 61 relative to the operation portion 611 (the right direction in FIG. 7) and rotatably attached to a leading guide supporting portion 602 of the guide mechanism unit 6 by a rotating shaft 613b. On the other end side of the connecting plate 613 on the opposite side of the operation portion 611 relative to the rotating shaft 613b, an elastic member 614 configured with a coil spring or the like is provided, the elastic member 614 energizing the other end side of the connecting plate 613 outward in the radial direction.

By the elastic member 614 energizing the other end side of the connecting plate 613 outward in the radial direction, the leading guide member 61 is pushed by the connecting plate 613 and is always pushed inward in the radial direction. However, when a pressing force exceeding the energizing force of the elastic member 614 acts on the leading guide member 61 outward from inside in the radial direction, the leading guide member 61 can move outward in the radial direction to expand in diameter, along a white arrow in FIG. 7. When the pressing force is released, the leading guide member 61 is reduced in diameter inward in the radial direction by the energizing force of the elastic member 614 acting thereon, and returns to a steady state.

The plurality of leading guide members 61 are provided so as to be movable in the central axis direction of the stator core 2 by driving of an actuator 610 for driving leading guide members, which is provided in the guide mechanism unit 6. The actuator 610 is controlled by a controller 10 of the stator assembly apparatus 1 shown in FIG. 1. When being driven, the actuator 610 causes the leading guide supporting portion 602 to move in a direction toward the stator core 2 and in a direction away from the stator core 2, along the central axis direction of the stator core 2. By the leading guide supporting portion 602 moving in the direction toward the stator core 2, the plurality of leading guide members 61 are inserted inside the pieces of insulating paper 24 in their corresponding slots 22, respectively, in the central axis direction of the stator core 2. By the leading guide supporting portion 602 moving in the direction away from the stator core 2, the plurality of leading guide members 61 are withdrawn outside in the central axis direction of the stator core 2 from inside the pieces of insulating paper 24 in the slots 22.

Each reinforcing guide member 62 is configured with a rod-shaped body with such a length that the reinforcing guide member 62 can be inserted inside the piece of insulating paper 24 mounted inside the slot 22, the length being shorter than the length of the leading guide member 61. The section orthogonal to the longitudinal direction of the reinforcing guide member 62 has a quadrilateral shape with rounded corners except for a tapered tip portion. A longitudinal width W21 (see FIG. 13A) of the reinforcing guide member 62 along the radial direction of the stator core 2 is substantially the same as the longitudinal width W11 of the leading guide members 61. A lateral width W22 (see FIG. 13A) of the reinforcing guide member 62 along the circumferential direction of the stator core 2 is substantially the same as the lateral width W12 of the leading guide members 61.

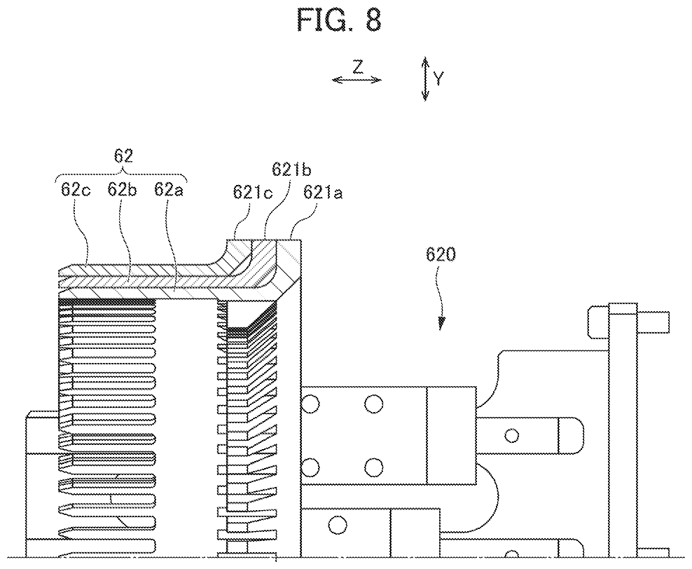

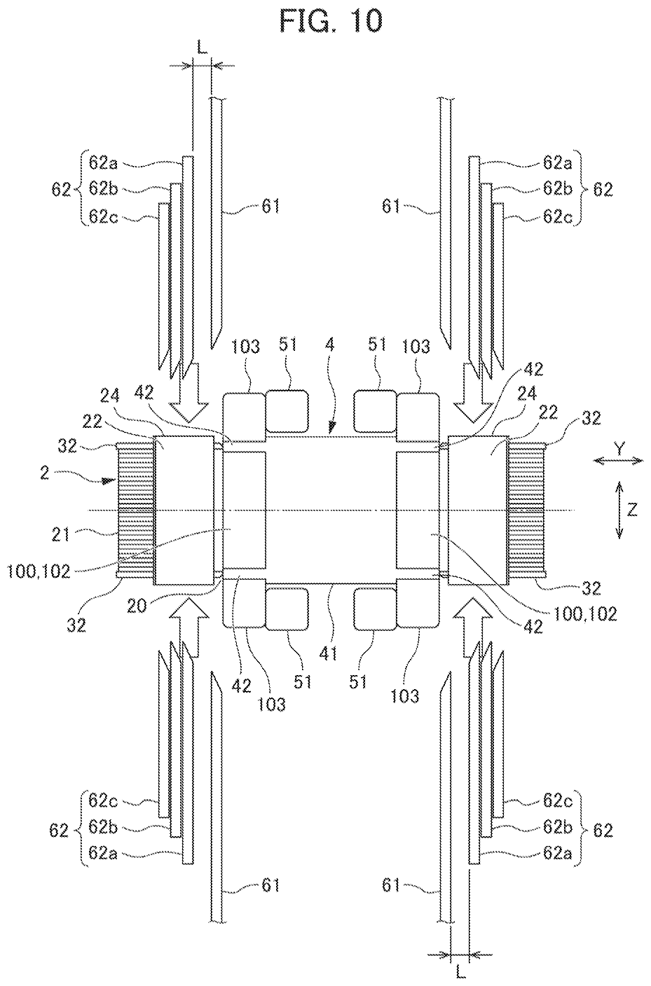

Three reinforcing guide members 62 are provided for one slot 22. That is, as shown in FIG. 8, the three reinforcing guide members 62 include a first reinforcing guide member 62a on the radially innermost side, a second reinforcing guide member 62b arranged on the outer side of the first reinforcing guide member 62a in the radial direction, and a third reinforcing guide member 62c arranged on the outer side of the second reinforcing guide member 62b in the radial direction. The first reinforcing guide members 62a, the second reinforcing guide member 62b, and the third reinforcing guide members 62c are annularly arranged, with the same arrangement pitch as the arrangement pitch of the slots 22 and stacked in the radial direction. However, the first reinforcing guide member 62a on the radially innermost side, among the three reinforcing guide members 62, and the leading guide member 61 are separated from each other by a distance L corresponding to each of the longitudinal width W11 of one leading guide member 61 and the longitudinal width W21 of each of one first reinforcing guide member 62a, one second reinforcing guide member 62b, and one third reinforcing guide member 62c (see FIGS. 10 and 13A). The specific distance L is to be appropriately set according to the specifications of the slots 22, the type of the insulating paper 24, and the like and is not especially limited. In the present embodiment, the distance L is set to 4.2 mm.

As shown in FIG. 8, the tips of the first reinforcing guide member 62a, the second reinforcing guide member 62b, and the third reinforcing guide member 62c are formed being tapered. On the base end sides of the first reinforcing guide members 62a, the second reinforcing guide members 62b, and the third reinforcing guide members 62c, operation portions 621a, 621b and 621c protruding outward in the radial direction are annularly formed, respectively. The operation portions 621a, 621b, and 621c are individually coupled with actuators 620 of the guide mechanism unit 6, respectively.

The first reinforcing guide members 62a, the second reinforcing guide members 62b, and the third reinforcing guide members 62c are provided so as to be individually movable in the central axis direction of the stator core 2 by driving of the actuators 620 for driving reinforcing guide members, which are provided in the guide mechanism unit 6. As shown in FIG. 6, the actuators 620 include a first reinforcing guide actuator 620a, a second reinforcing guide actuator 620b, and a third reinforcing guide actuator 620c, which are individually controlled by the controller 10 of the stator assembly apparatus 1 shown in FIG. 1.

When being driven, the actuators 620 cause the first reinforcing guide members 62a, the second reinforcing guide members 62b, and the third reinforcing guide members 62c to individually move in the direction toward the stator core 2 and in the direction away from the stator core 2, along the central axis direction of the stator core 2. By moving in the direction toward the stator core 2, the first reinforcing guide members 62a, the second reinforcing guide members 62b, and the third reinforcing guide members 62c are inserted inside the pieces of insulating paper 24 in their corresponding slots 22, respectively, in the central axis direction of the stator core 2. By moving in the direction away from the stator core 2, the first reinforcing guide members 62a, the second reinforcing guide members 62b, and the third reinforcing guide members 62c can be individually withdrawn outside in the central axis direction of the stator core 2 from inside the pieces of insulating paper 24 in the slots 22, respectively.

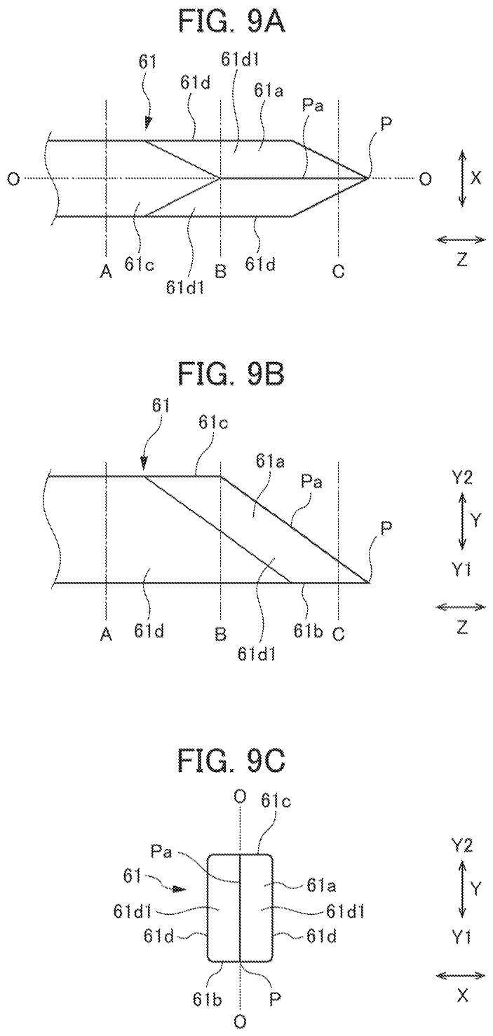

Here, the shape of the tip of each leading guide member 61 will be described with reference to FIGS. 9A to 9C. A tip portion 61a of each leading guide member 61 has an apex P on one end portion 61b side of the leading guide member 61. The tip portion 61a of the leading guide member 61 is inclined along the radial direction of the stator core 2, from the apex P toward the other end portion 61c side of the leading guide member 61 along the radial direction of the stator core 2. Though the tip portion 61a of each leading guide member 61 of the present embodiment is linearly inclined as shown in FIG. 9B, it may be inclined like drawing a curve.

Furthermore, as shown in FIGS. 9A and 9C, the tip portion 61a of the leading guide member 61 has a shape tapered toward a center line O of the leading guide member 61 along the radial direction of the stator core 2. Both side faces 61d of the leading guide member 61 facing the circumferential direction of the stator core 2 are gradually thinner as being closer to the tip, and abut each other almost on the center line O. Thereby, a ridgeline Fa inclined from the apex P on the one end portion 61b side toward the other end portion 61c side is formed on the tip portion 61a of the leading guide member 61. The ridgeline Pa substantially corresponds to the center line O of the leading guide member 61. On the leading guide member 61 of the present embodiment, inclined faces 61d1 formed by both side faces 61d being tapered are formed by linearly inclined planes as shown in 9A, but may be formed by curved surfaces.

The leading guide member 61 having such a tip shape is attached to the guide mechanism unit 6 so as to be arranged on the outer side in the radial direction of the stator core 2 (the y1 side) as shown in FIGS. 9B and 9C.

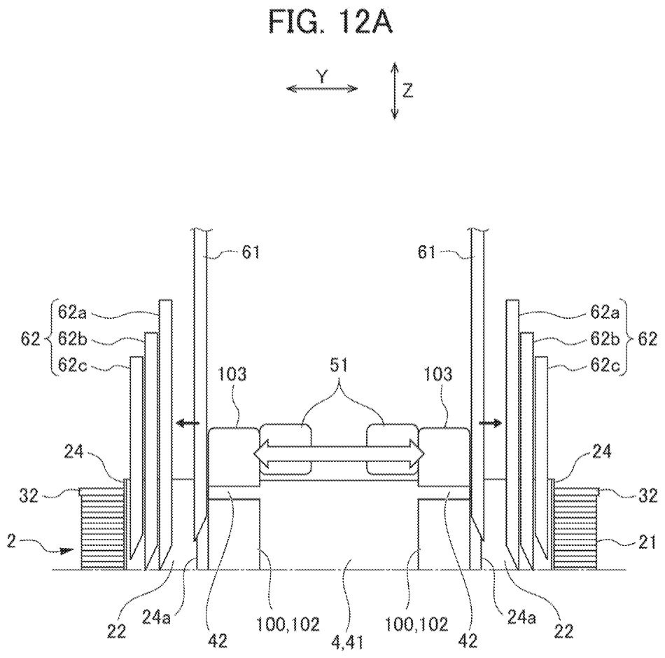

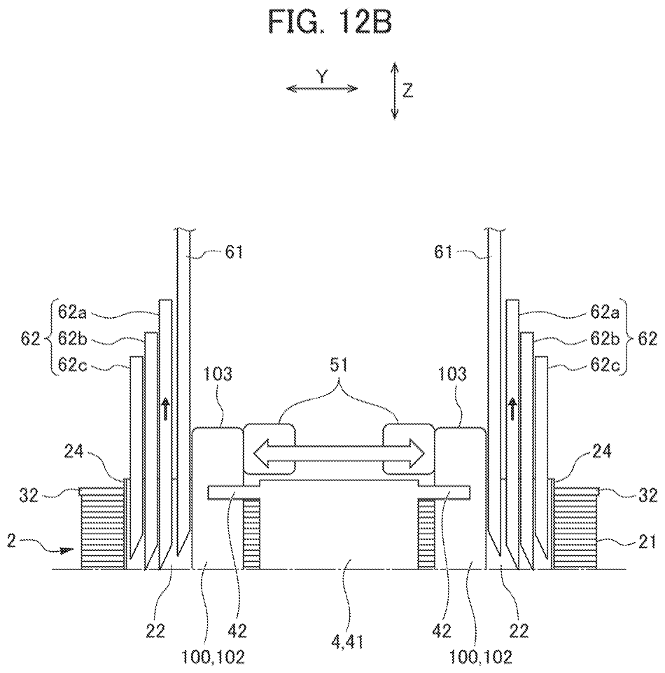

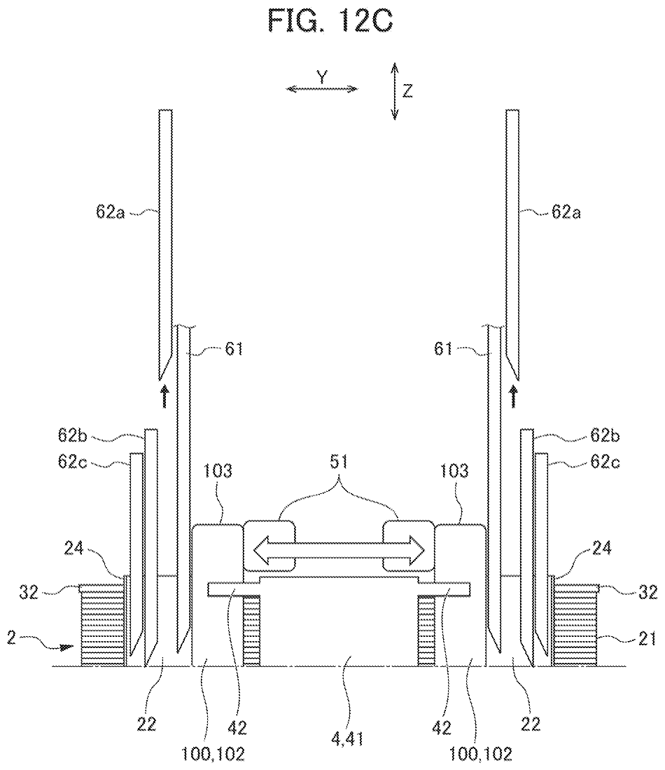

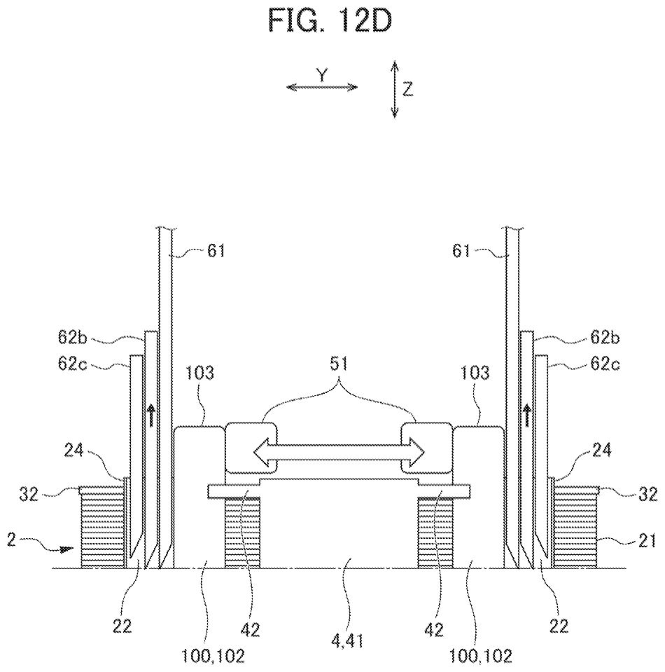

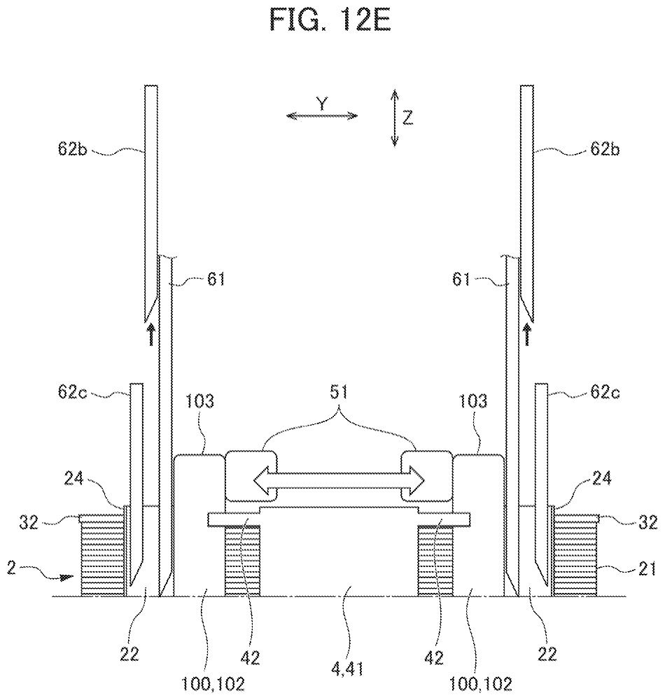

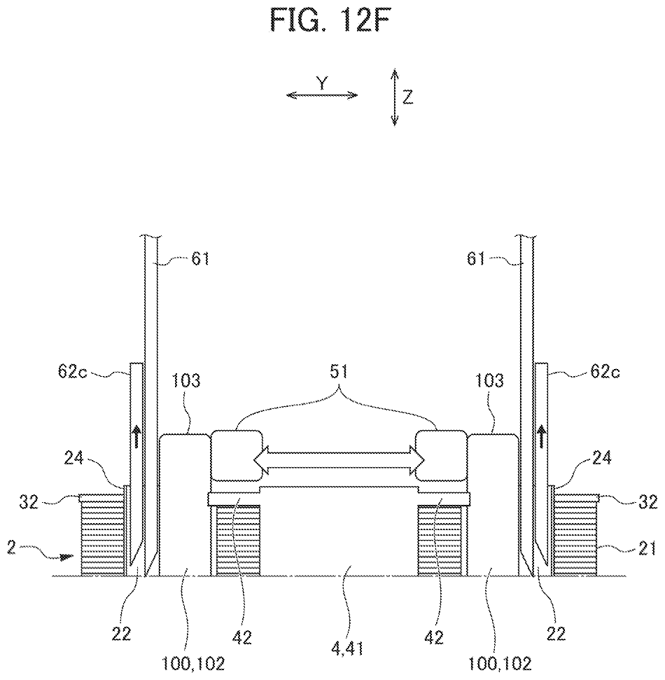

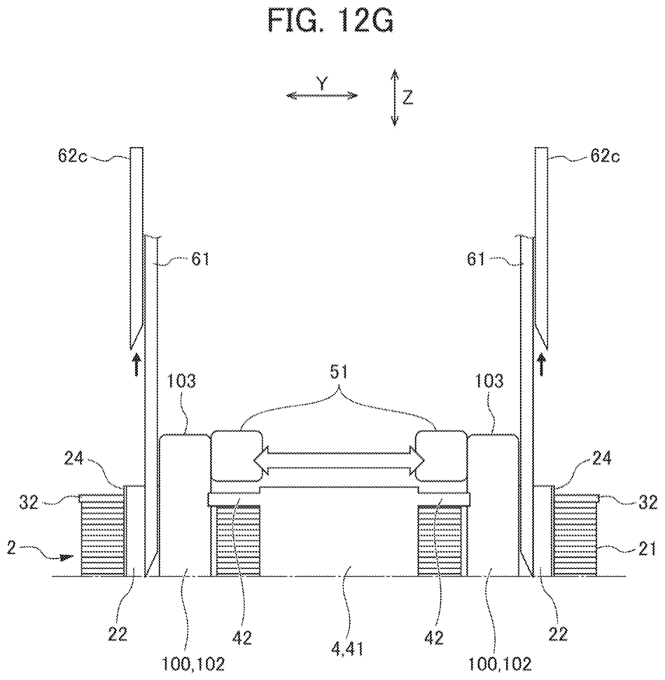

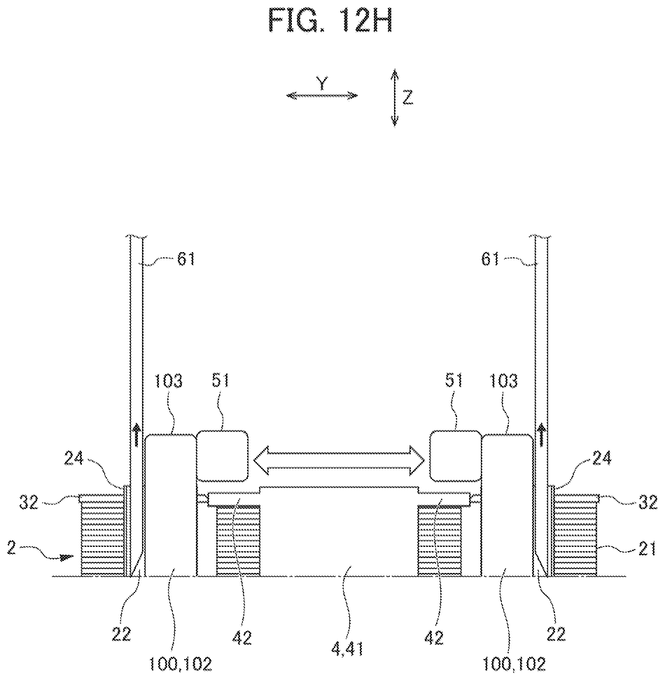

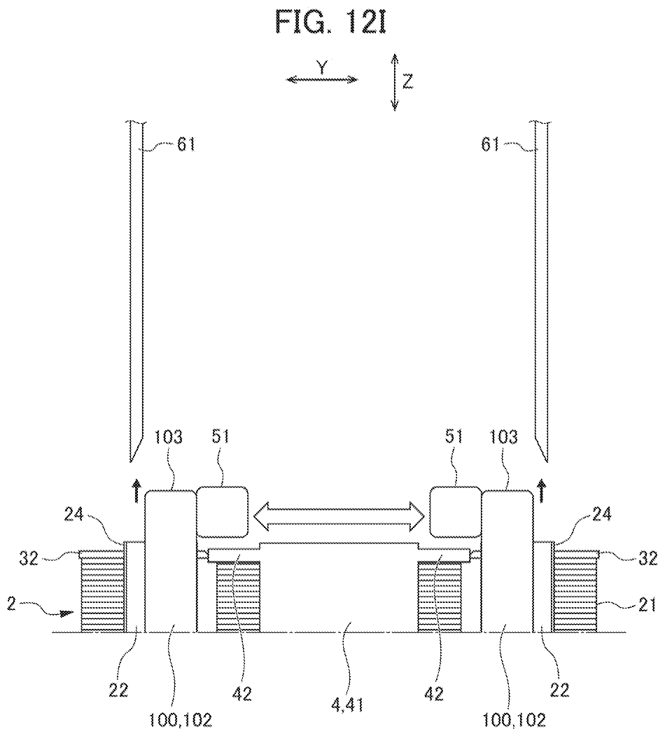

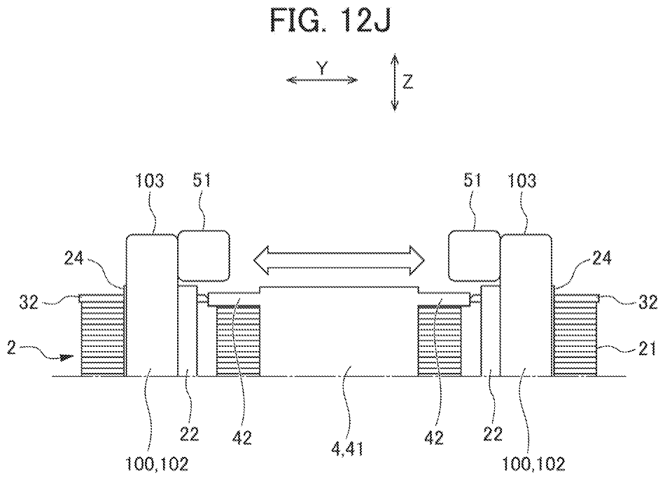

Next, description will be made on a process of inserting the straight portions 102 of the belt-shaped coil 100 inside the pieces of insulating paper 24 in the slots 22 of the stator core 2 in the stator assembly apparatus 1. FIG. 10, FIGS. 10A to 11C, and FIGS. 12A to 12J schematically show an operation process of inserting the belt-shaped coil 100 wound around the coil winding jig 4 inside the pieces of insulating paper 24 in the slots 22 of the stator core 2 from inside the stator core 2. Since the operation processes on both sides of the stator core 2 in the central axis direction progress in synchronization with each other, FIGS. 12A to 12J show only the operation process on one side of the stator core 2 in the central axis direction. FIGS. 13A to 13J schematically show the leading guide member 61 and the reinforcing guide members 62 in one slot 22 of the stator core 2. FIGS. 13A to 13J temporally correspond to FIGS. 12A to 12J. In FIG. 10, FIGS. 12A to 12J, and FIGS. 13A to 13J, the positioning jig 3 is not shown.

First, as shown in FIG. 10, after the coil winding jig 4 around which the belt-shaped coil 100 is wound is supported in the through-hole 20 of the stator core 2 by the coil expansion mechanism units 5, the actuators 610 and 620 of the guide mechanism unit 6 are drive-controlled by the controller 10 to insert all the leading guide members 61 and the reinforcing guide members 62 inside the pieces of insulating paper 24 in the slots 22, respectively, from both outer sides of the stator core 2 in the central axis direction. The tips of the leading guide members 61, and the tips of the reinforcing guide members 62 inserted inside the piece of insulating paper 24 in each slot 22 are arranged to face each other in the slot 22.

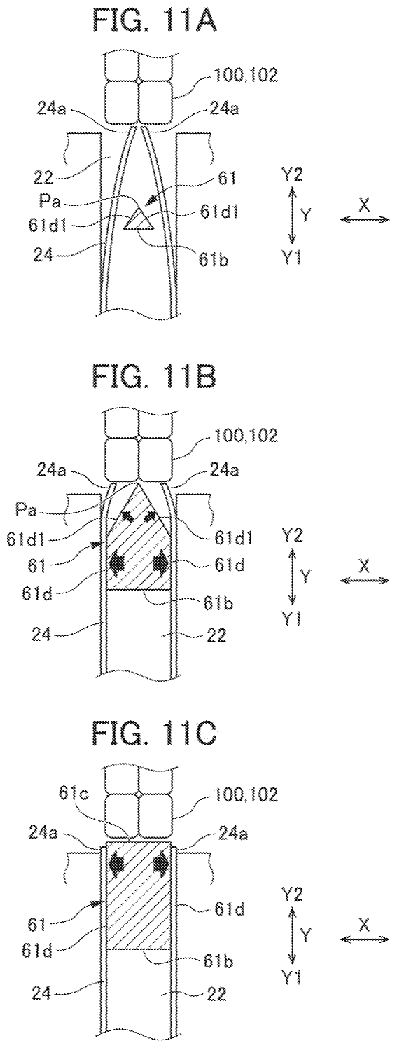

Each leading guide member 61 is arranged on the radially innermost side in the guide mechanism unit 6, and arranged near the opening portion 22a of the slot 22 when moving toward the stator core 2 and being inserted into the slot 22. Therefore, by moving toward the stator core 2, the leading guide member 61 is inserted into the inside of the piece of insulating paper 24 in a state of being in contact with the opening ends 24a of the piece of insulating paper 24 (FIG. 11C).

At this time, the leading guide member 61 enters the inside of the piece of insulating paper 24 from the apex P side. Since the apex P is arranged on the outer side in the radial direction of the stator core 2 (the Y1 side) on the leading guide member 61, the leading guide member 61 enters the inside of the piece of insulating paper 24 from a position on the depth side (the Y1 side) relative to the opening ends 24a or the piece of insulating paper 24 in the slot 22 (FIG. 11A).

After that, as the leading guide member 61 is inserted more, the two inclined faces 61d1 advance toward the opening ends 24a of the piece of insulating paper 24 from inside, along the inclination of the tip portion 61a of the leading guide member 61. Thereby, even if the opening between the opening ends 24a of the piece of insulating paper 24 is almost as narrow as being closed, the opening ends 24a can be guided to open, from inside the piece of insulating paper 24. At the same time, both side faces 61d of the leading guide member 61 also guide the vicinities of the opening ends 24a of the piece of insulating paper 24 to gradually open outward from inside (FIG. 11B).

When insertion of the leading guide member 61 is completed, the leading guide member 61 is arranged in the slot 22 in a state of at least a part thereof being in contact with the opening ends 24a of the piece of insulating paper 24 in the slot 22. A side face on the other end portion 61c side of the leading guide member 61 is arranged at the same position as the opening ends 24a of the piece of insulating paper 24, or on the outer side of the slot 22 than the opening ends 24a, that is, on the inner side in the radial direction of the stator core 2 (the Y2 side) (FIG. 11C). Thereby, the opening between the opening ends 24a of the piece of insulating paper 24 increases by the width W0 of the belt-shaped coil 100 or more, and it is possible to, by the straight portions 102 of the belt-shaped coil 100 coming into contact with the leading guide member 61, smoothly introduce the straight portions 102 into the inside of the piece of insulating paper 24.

The tips of the reinforcing guide members 62 (the first reinforcing guide members 62a, the second reinforcing guide members 62b, and the third reinforcing guide members 62c) may be also formed in a shape similar to the shape of the tips of the leading guide members 61.

In a state immediately after all the leading guide members 61 and the reinforcing guide members 62 are inserted inside the pieces of insulating paper 24 in the slots 22, each leading guide member 61 is arranged in the slot 22 in the state of at least a part thereof being in contact with the opening ends 24a of the piece of insulating paper 24 as described above. The first reinforcing guide member 62a, the second reinforcing guide member 62b, and the third reinforcing guide member 62c, which are the reinforcing guide members 62, are arranged in a state of being stacked on the outer side in the slot 22 (on the depth side of the slot 22) in the radial direction. The leading guide member 61 and the first reinforcing guide member 62a on the radially innermost side are separated from each other by the distance L.

The state in which the leading guide member 61 and the reinforcing guide members 62 are inserted inside the piece of insulating paper 24 in the slot 22 is close to a state in which the straight portions 102 of the belt-shaped coil 100 are inserted inside the piece of insulating paper 24. Therefore, the piece of insulating paper 24 before the straight portions 102 of the belt-shaped coil 100 are inserted therein is in a state of the piece of insulating paper 24 after the straight portions 102 or the belt-shaped coil 100 are inserted, and the shape of the piece of insulating paper 24 is held in a proper shape prior to insertion of the belt-shaped coil 100. Moreover, since at least a part of the leading guide member 61 is arranged in each slot 22 in the state of being in contact with the opening ends 24a of the piece of insulating paper 24, it is possible to hold the opening ends 24a of the piece of insulating paper 24 in an opened state prior to insertion of the belt-shaped coil 100. As a result, the piece of insulating paper 24 is prevented from coming into contact with the belt-shaped coil 100 that is moving. Therefore, it is possible to smoothly introduce the belt-shaped coil 100 inside the piece of insulating paper 24.

After insertion of the leading guide members 61 and the reinforcing guide members 62 is completed, the controller 10 causes the coil expansion mechanism unit 5 to operate to expand the coil presser 51 in diameter in the direction of a white arrow shown in FIG. 12A. The coil end portions 103 of the belt-shaped coil 100 wound around the coil winding jig 4 is thereby pressed by the coil presser 51 expanding in diameter and move outward in the radial direction of the stator core 2. The belt-shaped coil 100 gradually expands in diameter, accompanying the movement, and the straight portions 102 gradually move toward the inside of the piece of insulating paper 24 in each slot 22 (FIGS. 12A and 13A).

The belt-shaped coil 100 expanded in diameter comes into contact with the leading guide member 61 arranged ahead in the movement direction of the belt-shaped coil 100, and presses the leading guide member 61 outward in the radial direction of the stator core 2 by being further pressed by the coil presser 51. By being pressed by the belt-shaped coil 100, the leading guide member 61 moves outward in the radial direction to reduce the distance L against the energizing force of the elastic member 614. As a result, the leading guide member 61 pressed by the belt-shaped coil 100 comes into contact with or close to the first reinforcing guide member 62a arranged on the radially innermost side among the reinforcing guide members 62 (FIGS. 12B and 13B).

When the leading guide member 61 is pressed by the belt-shaped coil 100, a pushing force inward in the radial direction occurs on the leading guide member 61 due to the energizing force of the elastic member 614. Therefore, while moving, being pushed by the belt-shaped coil 100, the leading guide member 61 moves inside the piece of insulating paper 24 while pushing the belt-shaped coil 100 against the coil presser 51 inward in the radial direction. The belt-shaped coil 100 is thereby always constricted between the leading guide member 61 and the coil presser 51 while moving. Therefore, loosening of the belt-shaped coil 100 on the front side in the movement direction is prevented. In the present embodiment, the connecting plate 613 and the elastic member 614 constitute pushers that push the belt-shaped coil 100 inward in the radial direction of the stator core 2.

When the leading guide member 61 moves so as to reduce the distance L and comes into contact with or close to the first reinforcing guide member 62a on the radially innermost side, the controller 10 causes the first reinforcing guide actuator 620a to be driven to cause the first reinforcing guide member 62a to move outward in the central axis direction of the stator core 2. The first reinforcing guide member 62a thereby retreats from inside the piece of insulating paper 24 in the slot 22. The leading guide member 61 and the second reinforcing guide member 62b after the retreat of the first reinforcing guide member 62a are separated from each other by the distance L (FIGS. 12C and 13C).

As the belt-shaped coil 100 further expands in diameter, the leading guide member 61 is pushed by the belt-shaped coil 100 and moves outward in the radial direction to reduce the distance L from the second reinforcing guide member 62b. As a result, the leading guide member 61 pressed by the belt-shaped coil 100 comes into contact with or close to the second reinforcing guide member 62b arranged on the radially innermost side, between the second reinforcing guide member 62b and the third reinforcing guide member 62c that remain in the slot 22 (FIGS. 12D and 13D).

When the leading guide member 61 moves so as to reduce the distance L and comes into contact with or close to the second reinforcing guide member 62b, the controller 10 causes the second reinforcing guide actuator 620b to be driven to cause the second reinforcing guide member 62b to move outward in the central axis direction of the stator core 2. The second reinforcing guide member 62b thereby retreats from inside the piece of insulating paper 24 in the slot 22. The leading guide member 61 and the third reinforcing guide member 62c after the retreat of the second reinforcing guide member 62b are separated from each other by the distance L (FIGS. 12E and 13E).

As the belt-shaped coil 100 further expands in diameter, the leading guide member 61 is pushed by the belt-shaped coil 100 and moves outward in the radial direction to reduce the distance L from the third reinforcing guide member 62c. As a result, the leading guide member 61 pressed by the belt-shaped coil 100 comes into contact with or close to the third reinforcing guide member 62c arranged on the radially innermost side, which remains in the slot 22 (FIGS. 12F and 13F).

When the leading guide member 61 moves so as to reduce the distance L and comes into contact with or close to the third reinforcing guide member 62c, the controller 10 causes the third reinforcing guide actuator 620c to be driven to cause the third reinforcing guide member 62c to move outward in the central axis direction of the stator core 2. The third reinforcing guide member 62c thereby retreats from inside the piece of insulating paper 24 in the slot 22. Inside the piece of insulating paper 24 after the retreat of the third reinforcing guide member 62c, a gap corresponding to the distance L is formed on the outer side of the leading guide member 61 in the radial direction (FIGS. 12G and 13G).

As the belt-shaped coil 100 further expands in diameter, the leading guide member 61 is pushed by the belt-shaped coil 100 and moves outward in the radial direction so as to reduce the distance L that remains in the slot 22. As a result, the leading guide member 61 pressed by the belt-shaped coil 100 comes into contact with or close to a wall surface 22b on the deepest side in the radial direction in the slot 22 (FIGS. 12H and 13H).

When the leading guide member 61 moves so as to reduce the distance L and comes into contact with or close to the wall surface 22b on the deepest side in the slot 22, the controller 10 causes the actuator 610 to be driven to cause the leading guide member 61 to move outward in the central axis direction of the stator core 2. The leading guide member 61 thereby retreats from inside the piece of insulating paper 24 in the slot 22. Inside the piece of insulating paper 24 after the retreat of the leading guide member 61, a gap corresponding to the distance L is formed between the straight portions 102 of the belt-shaped coil 100 and the wall surface 22b (FIGS. 12I and 13I).

When the belt-shaped coil 100 further expands in diameter, the belt-shaped coil 100 moves outward in the radial direction so as to reduce the distance L that remains in the slot 22. As a result, the straight portions 102 of the belt-shaped coil 100 are accommodated inside the piece of insulating paper 24 in the slot 22 (FIGS. 12J and 13J). The belt-shaped coil 100 is thereby mounted in the slots 22 of the stator core 2, and a stator 200 is completed (FIG. 14).

According to the stator assembly apparatus 1 and the stator assembly method according to the above embodiment, the following effects can be obtained. That is, the stator assembly apparatus 1 according to the present embodiment is a stator assembly apparatus for assembling the stator 200 by inserting the belt-shaped coil 100 into the slots 22 of the stator core 2 in which the pieces of insulating paper 24 are mounted, from inside the stator core 2. The stator assembly apparatus 1 includes leading guide members 61 provided movably along a central axis direction of the stator core 2, each of the leading guide members 61 being, by moving toward the stator core 2, inserted into the inside of the piece of insulating paper 2A before the belt-shaped coil 100 being inserted, and arranged ahead in the movement direction of the belt-shaped coil 100 moving toward the slot 22, in the state of at least a part of the leading guide member 61 being in contact with the opening ends 24a of the piece of insulating paper 24. The leading guide member 61 has a quadrilateral shape when viewed in the longitudinal direction; the tip portion 61a of the leading guide member 61 is inclined along the radial direction of the stator core 2 with one end portion side (the Y1 side) in the radial direction of the stator core 2 as the apex P, and has a shape tapered toward the center line O of the leading guide member 61 along the radial direction of the stator core 2; and the apex P is arranged on the outer side in the radial direction of the stator core 2. According to the above, even if the opening between the opening ends 24a of the piece of insulating paper 24 is almost as narrow as being closed, it is possible to smoothly insert the leading guide member 61 into the inside of the piece of insulating paper 24. The leading guide member 61 has a quadrilateral shape when viewed in the longitudinal direction, has a shape of being inclined along the radial direction of the stator core 2 with one end portion side (the Y1 side) in the radial direction of the stator core 2 as the apex P and being tapered toward the center line O along the radial direction of the stator core 2, and has a configuration in which the apex is arranged on the outer side in the radial direction of the stator core 2. The leading guide member 61 is inserted into the slot 22 in the state of at least a part thereof being in contact with the opening ends 24a of the piece of insulating paper 24. Therefore, it is possible to, only by inserting the leading guide member 61 into the inside of the piece of insulating paper 24, cause the opening ends 24a of the piece of insulating paper 24 to return to the opened state prior to insertion of the coil. Therefore, it is possible to provide the stator assembly apparatus 1 with a good workability of the stator 200.

In the present embodiment, the lateral width W12 of each leading guide member 61 along the circumferential direction of the stator core 2 is equal to or more than the width W0 of the straight portions 102 of the belt-shaped coil 100 along the circumferential direction of the stator core 2. According to the above, since it is possible to cause the opening between the opening ends 24a of the piece of insulating paper 24 to open wider than the width W0 of the straight portions 102 of the belt-shaped coil 100, the insertability of the belt-shaped coil 100 is further improved.

The stator assembly method according to the present embodiment is a stator assembly method for assembling the stator 200 by inserting the belt-shaped coil 100 into each of the slots 22 of the stator core 2 from inside the stator core 2, the pieces of insulating paper 24 being mounted in the slots 22. The stator assembly method includes the process of, before inserting the belt-shaped coil 100 into each of the slots 22, inserting each of the leading guide members 61 into the inside of the piece of insulating paper 24 from the outer side in the central axis direction of the stator core 2 such that the leading guide member 61 is arranged ahead in the movement direction of the belt-shaped coil 100 moving toward the slot 22, in the state of at least a part of the leading guide member 61 being in contact with the opening ends 24a of the piece of insulating paper 24. The leading guide member 61 has a quadrilateral shape when viewed in the longitudinal direction; the tip portion 61a of the leading guide member 61 is inclined along the radial direction of the stator core 2 with one end portion side (the Y1 side) in the radial direction of the stator core 2 as the apex P, and has a shape tapered toward the center line O of the leading guide member 61 along the radial direction of the stator core 2; and the apex P is arranged on the outer side in the radial direction of the stator core 2. According to the above, even if the opening between the opening ends 24a of the piece of insulating paper 24 is almost as narrow as being closed, it is possible to smoothly insert the leading guide member 61 into the inside of the piece of insulating paper 24. The leading guide member 61 has a quadrilateral shape when viewed in the longitudinal direction, has a shape of being inclined along the radial direction of the stator core 2 with one end portion side (the Y1 side) in the radial direction of the stator core 2 as the apex P and being tapered toward the center line O along the radial direction of the stator core 2, and has a configuration in which the apex P is arranged on the outer side in the radial direction of the stator core 2. The leading guide member 61 is inserted into the slot 22 in the state of at least a part thereof being in contact with the opening ends 24a of the piece of insulating paper 24. Therefore, it is possible to, only by Inserting the leading guide member 61 into the inside of the piece of insulating paper 24, cause the opening ends 24a of the piece of insulating paper 24 to return to the opened state prior to insertion of the belt-shaped coil 100. Therefore, it is possible to provide a stator assembly method with a good workability of assembly of the stator 200.

In the present embodiment, the lateral width W12 of each leading guide member 61 along the circumferential direction of the stator core 2 is equal to or more than the width W0 of the straight portions 102 of the belt-shaped coil 100 along the circumferential direction of the stator core 2. According to the above, since it is possible to cause the opening between the opening ends 24a of the piece of insulating paper 24 to open wider than the width W0 of the straight portions 102 of the belt-shaped coil 100, the insertability of the belt-shaped coil 100 is further improved.

The stator assembly apparatus 1 in the embodiment described above is configured such that the central axis direction of the stator core 2 and the coil winding jig 4 is arranged in the horizontal direction. However, the stator assembly apparatus 1 may be configured such that the central axis direction of the stator core 2 and the coil winding jig 4 is arranged in a direction other than the horizontal direction, such as the vertical direction.

### EXPLANATION OF REFERENCE NUMERALS

1 stator assembly apparatus

2 stator core

22 slot

24 insulating paper (insulating member)

24a opening end

61 leading guide member

61a tip portion

100 belt-shaped coil

200 stator

P apex

W0 width of belt-shaped coil

W12, W22 lateral width

What is claimed is:

1. A stator assembly apparatus for assembling a stator by inserting a coil into slots of a stator core in which insulating members are mounted, from inside the stator core, the stator assembly apparatus comprising:
leading guide members provided movably along a central axis direction of the stator core, each of the leading guide members being, by moving toward the stator core, inserted into an inside of the respective insulating member before the coil is inserted, and arranged ahead in a movement direction of the coil moving toward the respective slot, in a state of at least a part of the leading guide member being in contact with opening ends of the insulating member;
each of the leading guide members having a quadrilateral shape when viewed in a longitudinal direction;
a tip portion of each of the leading guide members being inclined along a radial direction of the stator core with one end portion side in the radial direction of the stator core as an apex, and having a shape tapered toward a center line of the leading guide member along the radial direction of the stator core; and
the apex being arranged on an outer side in the radial direction of the stator core.

2. The stator assembly apparatus according to claim 1, wherein a lateral width of the leading guide member along a circumferential direction of the stator core is equal to or more than a width of the coil along the circumferential direction of the stator core.

3. A stator assembly method for assembling a stator by inserting a coil into slots of a stator core in which insulating members are mounted, from inside the stator core, the stator assembly method comprising the processes of:
before inserting the coil into each of the slots, inserting each of leading guide members into an inside of the respective insulating member from an outer side in a central axis direction of the stator core such that the leading guide member is arranged ahead in a movement direction of the coil moving toward the respective slot, in a state of at least a part of the leading guide member being in contact with opening ends of the insulating member;
the leading guide member having a quadrilateral shape when viewed in a longitudinal direction;
a tip portion of the leading guide member being inclined along a radial direction of the stator core with one end portion side in the radial direction of the stator core as an apex, and having a shape tapered toward a center line of the leading guide member along the radial direction of the stator core; and
the apex being arranged on an outer side in the radial direction of the stator core.

4. The stator assembly method according to claim 3, wherein lateral width of the leading guide member along a circumferential direction of the stator core is equal to or more than a width of the coil along the circumferential direction of the stator core.
